(19) United States
(12) Patent Application Publication
(10) Pub. No.: US 2006/0036554 A1
(43) Pub. Date: Feb. 16, 2006

(54) Content and license delivery to shared devices

(75) Inventors: Christian E. Schrock, New York, NY (US); Yevgeny Zarakhovsky, Seattle, WA (US); James N. Reitz, Seattle, WA (US); Oliver R. Roup, Seattle, WA (US); Olivier Zoltan Peter Garamfalvi, Seattle, WA (US)

Correspondence Address: AMIN & TUROCY, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 10/916,722

(22) Filed: Aug. 12, 2004

(51) Int. Cl. H04L 9/00

(52) U.S. Cl. 705/75

(57) ABSTRACT

Systems and methodologies are provided for a Digital Rights Management (DRM) that permits a service provider implementing DRM (the Service), to distribute and use digital contents to a plurality of devices designated by a user, via employing a registration component and a DRM component. The registration component can associate a user with a particular device among the plurality of devices, and also associate the device with its DRM challenge. The DRM component can issue licenses for content(s) used on the particular device. Such an arrangement facilitates users' ability to roam and use a digital content purchased across a number of devices designated by the user and approved by the Service.

### TECHNICAL FIELD

The present invention relates generally to Digital Rights Management system implementations, and more particularly to systems and methods that permit a content provider to enable the distribution and usage of digital contents to a plurality of devices designated by a user.

### BACKGROUND OF THE INVENTION

Many traditional approaches to distributing stored content, such as audio, video, text or software content, involve distributing media (such as print media, magnetic or optical media and the like) which, once distributed, can typically be freely used by any person having possession of the media. Such a distribution system, however, imposes certain undesirable restraints on how the content is distributed. For example, in traditional distribution methods, payment (or a contract or commitment to make payment) is obtained at the time the media is distributed. One adverse consequence of such system is that the payment typically must be an all-or-nothing payment, i.e., payment for all content which is on the media, even though a customer may wish to have only a portion of such content.

Today, increasing advances in computer technology (e.g., microprocessor speed, memory capacity, data transfer bandwidth, software functionality, and the like) have generally contributed to increased computer application in various content distribution industries. Ever more powerful server systems, which are often configured as an array of servers, are generally provided to service requests originating from external sources such as the World Wide Web, for example. As local Intranet systems have become more sophisticated thereby requiring servicing of larger network loads and related applications, peer-to-peer file sharing and piracy over the Internet have grown accordingly as well. For example, today breaches of copyright law can be readily performed because of the ease with which digital files can be copied and transmitted. As such, content protection is of the utmost concern for content owners and distributors. In general, Digital Rights Management (DRM) can entail challenges for content communities in the current digital age.

Typically, in systems involving digital content distribution by service providers, there exists a one to one relationship (e.g., single user, single computer) between content consumer and the service provider, wherein the enablement of protected content is coupled to a single computer or media reader device. Such approach, although beneficial in certain schemes for avoiding unauthorized copying, has typically had other associated disadvantages. For example, cumbersome requirements are typically imposed for remembering, and then entering, the password when the media is provided in a second computer or reader, e.g., there is no provision for the media itself to provide, to a computer or reader, information regarding previous content enablement. In particular, when protection codes or keys are established and stored by a media fabricator (or the fabricator of a media player or host computer), or otherwise provided prior to distribution of content to a customer, the system is typically relatively inflexible, provides the potential for using a copy of the code or key to access multiple media, and presents a potential for interception of enabling keys or codes.

At the same time, users employ numerous devices and wish to access their purchased content from a plurality of devices. Yet, issuing licenses in conventional manner are typically not reliable due to cumbersome initializations, network conditions, possibility of break-in and the like. In addition, traditional ways of obtaining challenges and/or keys for reissued licenses do not provide for designation and/or identification of the device for which the license is re-issued thereto. Accordingly, content owners can be discouraged from permitting licenses to be re-issued when such is required. Put differently, owners of digital audio or video content will not distribute their works to platforms they consider “potentially hostile,” e.g., when there exists possibility for fraud, wherein no guarantee is available that the license is re-issued to the authorized device. The same is true of individual users being requested to reveal private information to remote systems. Thus, there exist a requirement that the remote system receiving the owner's information will behave as expected, which can necessitate that the platform have an open, auditable and comprehensible trusted computing base, and that the means to prove the possession and operation of such a computing base remotely to another party.

Accordingly, there is a need to overcome the aforementioned deficiencies associated with conventional systems and methodologies related to Digital Rights Management and content distribution.

### SUMMARY OF THE INVENTION

The following presents a simplified summary of the invention in order to provide a basic understanding of one or more aspects of the invention. This summary is not an extensive overview of the invention. It is intended to neither identify key or critical elements of the invention, nor to delineate the scope of the present invention. Rather, the sole purpose of this summary is to present some concepts of the invention in a simplified form as a prelude to the more detailed description that is presented hereinafter.

The present invention provides for systems and methods of Digital Rights Management (DRM) that allow a service provider implementing DRM (the Service) to enable distribution and usage of digital contents to a plurality of devices designated by a user, via employing a registration component and a DRM component. Such an arrangement facilitates users' ability to roam and use digital content (the Content) purchased across a number of devices designated by the user, and approved by the Service. The registration component can associate a user with a device, and the device with its DRM challenge (e.g., data that contains the DRM's installation's public key).

According to one particular aspect of the invention, licenses can be associated with users (e.g., UserIDs), and can be sent to down to devices registered by the user with the Service. Typically, a license can be issued to a DRM blackbox that created the challenge, and the public key associated with the challenge develops from the blackbox. A blackbox can issue multiple different challenges, and in general a license issued to any of such challenges can operate only on that blackbox. The license can be data allowing a specific device to decrypt digital data encrypted by DRM (Packaged Content), and requiring a license to use, which is identifiable via an identification associated therewith (ContentID). Such license can be encrypted to a public key contained in the DRM challenge. Once a license is delivered, it can be stored locally on the device by the DRM implementation and used when the appropriate piece of the Packaged Content needs to be accessed. As such, a shared secret exists between the Service server and the registered device, and the protocol therebetween can be authenticated by the shared secret, wherein licenses are unique to the device and purchased content to be played thereupon. Moreover, a license can also be disabled by the service provider implementing DRM (Service) that issued the license. A tracking component of the Service can also track what Content a user has purchased and the machines to which the associated licenses have been downloaded.

In a related aspect of the present invention, unique licenses having unique challenges can be assigned to each device being registered with the DRM component. Multiple users can be sharing multiple devices at the same time, with each shared device having one challenge. Each user can be associated with a device(s), and a challenge associated with that device. Accordingly, a shared device can have a single challenge assigned thereto, regardless of the number of users sharing it. Thus, should a requirement arise to update the challenge for a computer, update can be readily performed for such single challenge. It is to be appreciated that multiple challenges can also be assigned to the shared device, in accordance with other aspects of the invention. Moreover, the system can further comprise a security component that can restrict access and provide for an access control, in case of a plurality of users using a plurality of devices, on a same network.

In another aspect of the present invention, the license can be issued to a single device (main device), and thereafter sublicenses issued by the main device to other devices in communication therewith. Thus, a requirement for directly accessing the Service server by the plurality of devices can be mitigated. Moreover, sublicenses granted by the main device can transfer full or partial rights to other device and users. Also, a user employing the main device can function as a central center (e.g., broadcasting) that streams digital content to the other users qualified under sublicenses granted by the main device.

In accordance with an aspect of the present invention, the DRM challenge contains a versioning scheme. Typically, as long as a higher version of the DRM challenge is sent by the registered device to the Service server, a license can be re-issued to the registered device. For example, should an initial DRM version be breached by unauthorized entities, and thus begets invalidated by the Service, a next time a registered device employing the initial DRM challenge connects to the Service server, a new DRM challenge can be supplied thereto, without a license being issued to the earlier invalidated version. For example, in case of a breach, the DRM blackbox can be updated and a new challenge with an updated version can be created. Thus, the registered device can decrypt newly downloaded content, once it sends the new DRM challenge to the Service, and obtains a reissued license.

In a methodology according to one aspect of the present invention, a user (e.g., a person identifiable to the Service by a user identification—User ID) initially registers the device (e.g., personal computer, palm pilot, and the like) with the Service. Such registration can “individualize” the device with the DRM component by assigning a device identification (DeviceID), and for example providing for a public/private key that is unique to the interaction between the device and the Service. In addition, the DRM system can check whether the device has been previously individualized, and whether an earlier DeviceID already exists. Subsequently data containing the DRM installation's public key (DRM Challenge) is received by the Service from the registered device and associated with the Device ID. Such DRM challenge can also be associated with the UserID in the Service's database. Typically, the device itself need not maintain information about the user, as multiple users can register the same device with the Service. Purchasing the Content that is protected by the DRM from the Service, creates a license or packaged content down load (the “Task”) that can be stored in the service side database (the “Task Queue”). Likewise, when the user completes registration of the device, Tasks for the Content owned by the user can be stored in the Task Queue for that device.

In a related aspect, the device can at any time request its associated pending Tasks and initiate communication (e.g., via user interaction, a timer, system start up and the like) with the Service by identifying itself thereto via the DeviceID. Next, the Service can find all Tasks in the Task Queue associated with that Device ID, and send them to the device along with matching task identifications (Task IDs). The Service can also locate license tasks in the Task Queue for the DeviceID, and retrieve the DRM Challenge corresponding to that Device ID from the database of the Service. The Service can then issue licenses for the device, so that the device can decrypt the packaged content. Typically, such licenses can be used only by the DRM implementation that issued the stored DRM Challenge. The device can then send acknowledgement to the Service for the TaskID of each task completed. Based on such acknowledgement, the Service can then mark the Task corresponding thereto as completed, to avoid a re-send. Other algorithms can also be employed to prevent a re-send.

In another aspect of the present invention, a device registered with the Service can be unregistered by the user. Upon such request, the Service can determine the set of ContentIDs for which the user has received Licenses on the given DeviceID to be unregistered. During such un-registration, content on the device can be disabled, provided that such content has not been purchased by another user sharing the same computer. A reference count can be performed on the device to be unregistered, to verify number of users and their respective contents purchased. Such licenses of other users continue to remain on the device, with the remaining licenses disabled as requested by the un-registering user.

To the accomplishment of the foregoing and related ends, the invention, then, comprises the features hereinafter fully described. The following description and the annexed drawings set forth in detail certain illustrative aspects of the invention. However, these aspects are indicative of but a few of the various ways in which the principles of the invention may be employed. Other aspects, advantages and novel features of the invention will become apparent from the following detailed description of the invention when considered in conjunction with the drawings.

### BRIEF DESCRIPTION OF THE DRAWINGS

FIG. 1 is a block diagram of a content and license delivery system in accordance with an aspect of the present invention.

FIG. 2 is a schematic diagram illustrating a multiple user and authentication system in accordance with an aspect of the present invention.

FIG. 3 illustrates a plurality of client devices that request connection to the Service in accordance with an aspect of the present invention.

FIG. 4 illustrates a methodology according to one aspect of the present invention.

FIG. 5 illustrates a block diagram for another array of devices with a license/sublicense arrangement in accordance with a particular aspect of the present invention.

FIG. 6 illustrates an exemplary methodology according to one aspect of the present invention, for un-registering a device

FIG. 7 illustrates components associated with a Content list system being employed as part of a shopping system for purchasing digital contents from the Service.

FIG. 8 illustrates a suitable computing environment on the client as well as the server side illustrated wherein various aspects of the present invention can be implemented.

FIG. 9 illustrates a client-server system that can consume Content according to one aspect of the present invention.

### DETAILED DESCRIPTION OF THE INVENTION

The present invention is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

As used in this application, the terms “component,” “handler,” “model,” “system,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal).

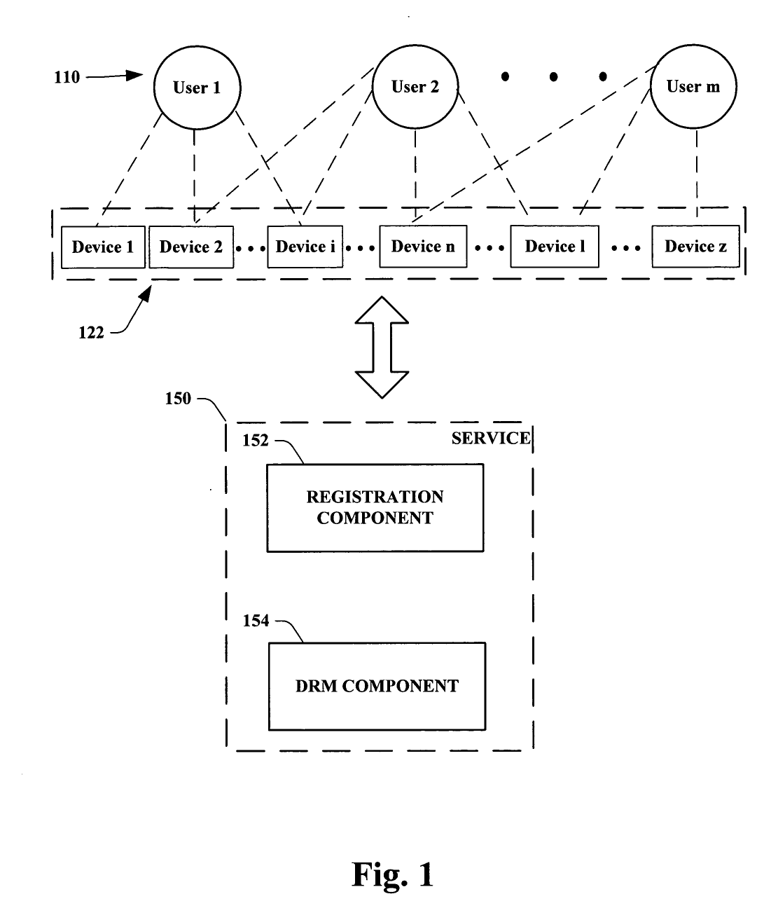

The present invention provides for systems and methods that facilitate users' ability to roam and use a digital content purchased across a plurality of devices registered with a registration component of a content service provider (the Service) that implements Digital Rights Management (DRM). Referring initially to FIG. 1 a block diagram of a content and license delivery system in accordance with an aspect of the present invention is illustrated. A plurality of users 1 thru m (m being an integer) who are uniquely identifiable individuals can each employ a plurality of devices (i, n, 1, z being integers). Example of devices can include computers, PDAs, step-top box and in general any electronic device capable of DRM installation with a unique blackbox. Moreover, users can share devices according to various combinations and mapping schemes, wherein any subset of users, can employ any subset of devices. The plurality of Devices 122 can be in communication with the Service 150. The Service 150 provides digital content (the Content), which can be protected by DRM.

According to one aspect of the present invention, the Service 150 enables distribution and usage of digital contents to the plurality of devices 122 designated by the users 110, via employing a registration component 152 and a DRM component 154. Such an arrangement facilitates users' 110 ability to roam and use a digital content purchased across the plurality of devices 122 designated by a user and approved by the Service 150. Such Content can be identifiable via an identification associated therewith (ContentID). Moreover, the registration component 152 can designate an identification (UserID) for each registered user, and associate such user with a device(s). In addition, the registration component 152 can associate the device with a piece of data that contains the DRM's installation's public key (DRM challenge), assigned by the DRM component 154.

In addition, licenses granted by the DRM component 154 can be associated with users 110, e.g. via User IDs, and can be sent to down to devices registered by the user with the Service 150. The license can be a piece of data allowing a specific device among the devices 122 to decrypt a piece of Content comprising digital data encrypted by DRM and requiring a license to use, and identifiable via the ContentIDs. In general, once the DRM component 154 issues a license to a DRM challenge of a device, the license can only be used by the device that issued that DRM challenge. The license can be encrypted to a public key contained in the DRM challenge. Once a license is delivered, it can be stored locally on the device by the DRM implementation and used when the appropriate piece of the Packaged Content needs to be accessed. Put differently, a shared secret exists between the Service server and the registered device, and the protocol therebetween can be authenticated by the shared secret. It is to be appreciated that other type of authentication procedures can also be employed and are well within the realm of the subject invention.

In a related aspect of the present invention, the established shared secret between the Service and the registered device(s), can be a public key-private key signature scheme. The basic concept of public-key cryptography is that every DRM Content transfer will be given a key pair that includes both a private key and a public key. Such a key can be an algorithm that receives the bits of a file and generates a numerical sequence from the bits in the file. The private key can be a unique key that the Service assigns and is intended to be kept secret by the Service. The public key is typically made available to other devices. The public key can be used to verify that the digital signature on a received content is authentic (e.g., that the digital signature was created with the private key). A Content can be encrypted with a private key and a public key used to decode the encryption. Various hashing algorithms such as secured hash algorithms (SHA) can also be employed therewith.

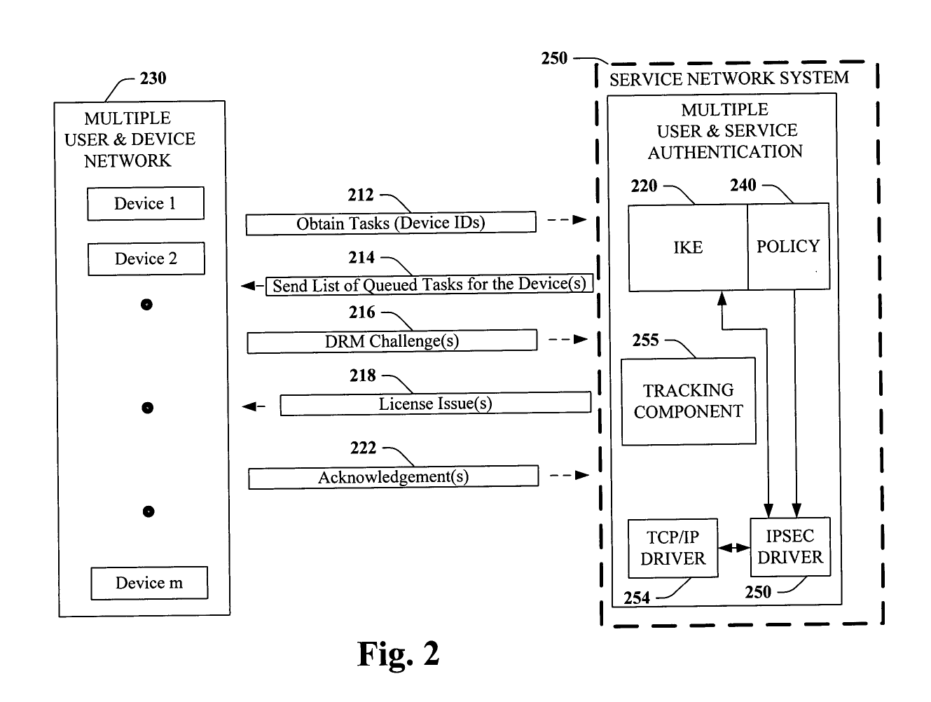

According to a further aspect of the present invention, a robust DRM system for Content delivery to devices 122 that communicate via the internet with the Service 150 is arranged, wherein various intermediate negotiating as part of an Internet Key Exchange (IKE) and Internet Protocol Security (IPSec) occur. Such an arrangement is described by referring to FIG. 2. The Service net work system 250 can include an Internet Key Exchange (IKE) subsystem 220 for securing network traffic between the Service network system 250 and the network of devices 230. The Service network system 250 can also include policy modules 240 to enable configuration of the IKE subsystems 230. The policy module 240 can also provide security configuration information to Internet Protocol Security (IPSec) drivers 250 which communicate via TCP/IP driver 254 thereby enabling secure network traffic between the Service network 250 and multiple user and device net work 230.

Upon registration of users (via UserIDs) and devices (via DeviceIDs) a negotiation phase can be established between the Internet Key Exchange subsystems 220 and the multiple user and device network 230 in order to form a secure trust for the Service network system 250, and to authenticate Device IDS and User IDs associated with the Service.

For example, a user (e.g., a person identifiable to the service provider by a user identification—User ID) initially registers the device (e.g., personal computer, palm pilot, and the like) with the Service. Such registration can “individualize” the device with the DRM component by assigning a device identification (DeviceID) at 212, and for example providing for a public/private key, as described supra, which is unique to the interaction between the device(s) 230 and the Service 250. In addition, the Service 250 can check whether the device has been previously individualized, and whether an earlier DeviceID already exists. Purchase of the Content that is protected by the DRM from the Service 250 can create a license and/or packaged content down load (the “Task”) that can be stored in the service side database (the “Task Queue”). Such Task can be identified by a unique identifier, for example by a TaskID. When the Service 250 sends the list of queued tasks at 214 to a device that is part of the multiple user and device network 230, the DRM challenge for that device is subsequently received at 216 by the Service 250. Such DRM challenge can be associated with the Device ID and the UserID in the Service's 250 database (not shown). Typically, the device itself need not maintain information about the user, as multiple users can register the same device with the Service 250. Also, and in general, a license issued to a specific DRM challenge can only be used by the device that issued that challenge. Moreover, to avoid a re-send, the device can then send an acknowledgement 222 to the Service 250. In addition, a tracking component 255 can be provided as part of the Service can track what content a user has purchased and the machines to which licenses have been downloaded. Such tracking component 255 can also provide notifications to users, for example if a user is attempting to buy a piece of Content for a second time, the user can be warned accordingly. In addition, the tracking component 255 can track a number of burn counts per machine, when the license so permits.

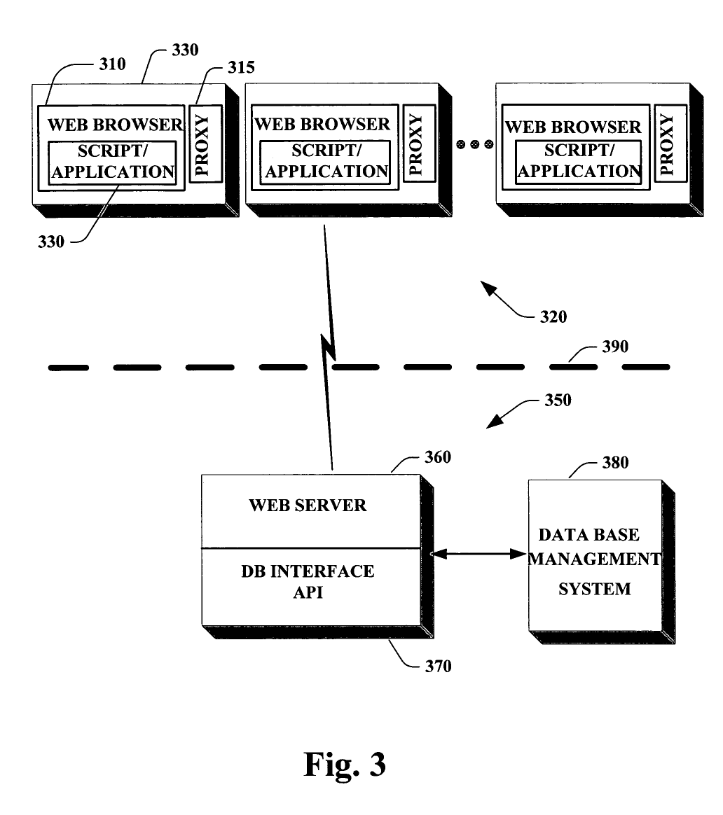

FIG. 3 illustrates a plurality of client devices that request connection to the Service in accordance with an aspect of the present invention, wherein running on each of the client devices 320 can be a client process, for example, a web browser 310. Likewise, running on the Service server 350 can be a corresponding server process, for example, a web server 360. In addition, embedded in the Web Browser 310 can be a script or application 330, and running within the run-time environment 330 of the client device 320, can exist a proxy 315 for packaging and unpacking data packets formatted. Communicating with the Service server 350 can be a database management system (DBMS) 380, which manages access to a Content database (not shown). The DBMS 380 and the database (not shown) can be located in the Service server itself, or can be located remotely on a remote database server (not shown). Running on the Service side Web server 360 is a database interface Applications Programming Interface (API) 370, which provides access to the DBMS 380. The client computer 320 and the Service server 350 can communicate with each other through a network 390. When the client process, e.g., the Web browser 310, requests Content from the Service, the script or application 330 issues a query, which is sent across the network (e.g., internet) 390 to the server computer 350, where it is interpreted by the Service server process, e.g., the Web server 360. The client's 320 request to Service server 350 can contain multiple commands, and a response from server 350 can return a plurality of licenses and/or Contents.

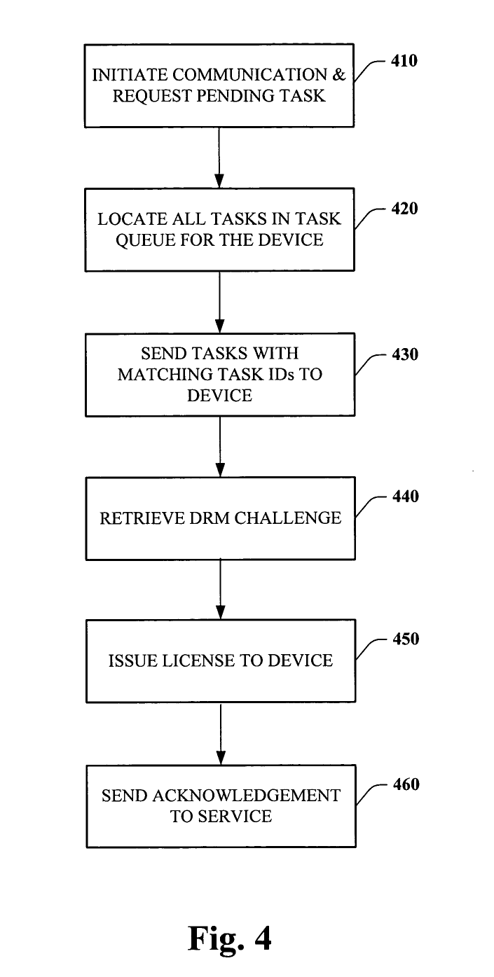

Referring now to FIG. 4, a methodology according to one aspect of the present invention is illustrated. At 410 the device initiates communication with the Service and request its associated pending Tasks. Such initiation can be via user interaction, a timer, system start up and the like, wherein the device identifies itself to the service provider via the DeviceID. Next, and at 420 the service provider implementing the DRM of the present invention locates all Tasks in the Task Queue associated with that Device ID, and sends them to the device along with matching Task IDs, at 430. Subsequently, at 440 the Service can also locate license tasks in the Task Queue for the DeviceID, and retrieve the DRM Challenge corresponding to that Device ID from the database of the Service. At 450, the Service can then issue licenses for the device to decrypt the packaged content. Typically, such licenses can be used only by the DRM implementation that issued the stored DRM Challenge. The device can then send acknowledgement to the Service for the TaskID of each task completed, at 460. Based on such acknowledgement, the Service can then mark the Task corresponding thereto as completed, to avoid a re-send. Other algorithms can also be employed to prevent a re-send. The DRM challenge can also contain a versioning scheme, wherein as long as a higher version of the DRM challenge is sent by the registered device to the Service server, a license can be re-issued to the registered device. In particular, if an initial DRM challenge is invalidated by the Service, e.g., for a security breach, a next time a registered device employing the initial DRM challenge connects to the Service server, a new DRM challenge can be supplied thereto, without a license being issued to the earlier invalidated version. Thus, the registered device can decrypt newly downloaded content, once it sends the new DRM challenge to the Service, and obtains a reissued license.

While the exemplary method is illustrated and described herein as a series of blocks representative of various events and/or acts, the present invention is not limited by the illustrated ordering of such blocks. For instance, some acts or events may occur in different orders and/or concurrently with other acts or events, apart from the ordering illustrated herein, in accordance with the invention. In addition, not all illustrated blocks, events or acts, may be required to implement a methodology in accordance with the present invention. Moreover, it will be appreciated that the exemplary method and other methods according to the invention may be implemented in association with the method illustrated and described herein, as well as in association with other systems and apparatus not illustrated or described.

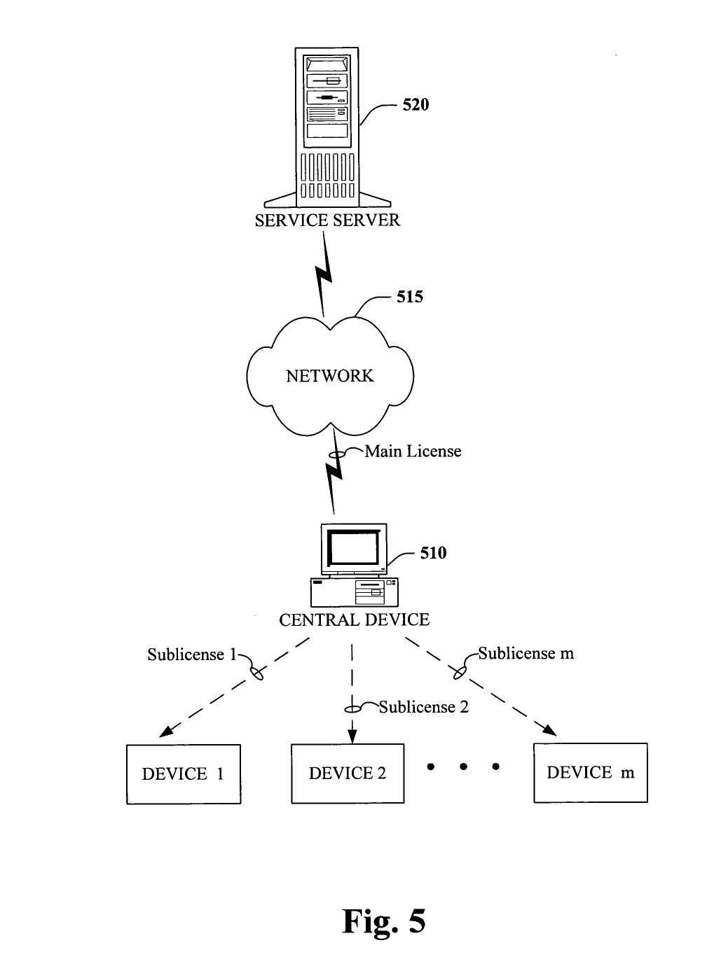

FIG. 5 illustrates a block diagram for another arrangement of devices in accordance with another aspect of the present invention. As illustrated, a central device 510 can be issued a license by the server, and thereafter such central device 510 can issue sublicenses to devices 1 thru m (m being an integer). Thus, a requirement for directly accessing the Service server by the plurality of devices 1 thru m can be mitigated. Moreover, sublicenses granted by the main device can transfer full or partial rights to devices 1 thru m. Also, a user employing the main device 510 can function as a central communication center (e.g., music broadcasting) for streaming digital content to other users sublicensed under the initial license to the main device. When the central device 510 connects to the Service server 520, via the network 515 (e.g., the internet) the Service server 520 can check to determine whether any purchased music by the primary user employing the central device 510 has not yet been authorized. Moreover, a main license can be retransmitted if the central device 510 fails to receive it for any reason. As explained in detail supra, licenses can be typically targeted at specific DRM individualization.

Additionally, various content sharing can be provided between the central device 510 and the other devices 1 thru m. In particular, the type and/or size of the content desired for “sharing” from one location (e.g., central location) to another (e.g., secondary location) can be examined. This information can be employed as a factor when determining which communication channel to effectuate the content sharing. This determination can also be based at least in part upon which communication channels are open and available between the sharing parties. Other factors that can influence the manner in which content can be transported or shared include the communication connection type or speed, the security associated with the connection, the identity of the users involved (e.g., a user that is providing Content and a user wishing to access the content), sharing rights, and/or access rights. For example, a user may be restricted from sharing certain types of content. Similarly, a user may be restricted from accessing content of a particular type or size. Various channels can be available given the type and size of content to be shared or transported. For instance, a first channel can relate to direct access whereby a first device can directly connect to and access content from the central device. A second channel can be a proxy server in which there is constant communication between the devices and the proxy but no information is saved locally. A third channel may involve a web server on the internet where a shared folder can be maintained and accessed by any number of computers permitted thru the license, and the like. Thus, such aspect of the present invention can also optimize file sharing between the central computer that obtains a primary license and the other sublicensed devices 1 thru m.

In a related aspect of the present invention, content to be shared can be placed in a virtual share space, for example. The virtual share space can be created by a primary user employing the central device, wherein the primary user can identify the content such as by file name. The primary user can also identify the respective users who are permitted to access such content with each respective file. Thus, the virtual share space can include a plurality of files with each file or share space associated with the (secondary) users who have been granted access via sublicenses to the particular file(s) or share space. Put differently, each file or group of files can be shared with different users and it is possible that not all identified users will have access to all of the content in any one particular share space.

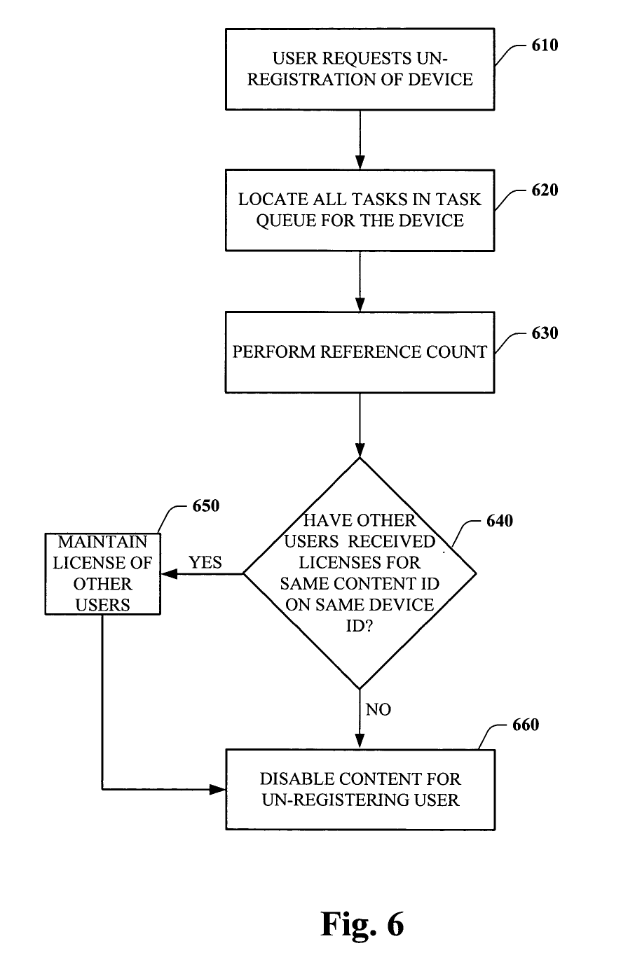

In another aspect of the present invention, a device registered with the Service can be unregistered by the user. FIG. 6 illustrates an exemplary methodology according to one aspect of the present invention, for un-registering a device. Initially, and at 610 a user requests un-registration of a device that has been individualized earlier with the Service. Such individualization performed earlier, has provided the device with the DRM implementation by assigning a device identification (DeviceID), and for example providing for a public/private key that enabled the interaction between the device and the Service. Upon a request for un-registration issued by a user, the Service at 620 can determine the set of ContentIDs for which the user has received Licenses on the given DeviceID to be unregistered. During the un-registration process, content on the device can be disabled, provided that such content has not been purchased by another user sharing the same computer. For example, as depicted at 630 a reference count can be performed on the device, and at 640 a determination made whether other users sharing the device have purchased same content. If so, at 650 licenses are maintained for such other users, and the license(s) for the un-registering user can be removed at 660.

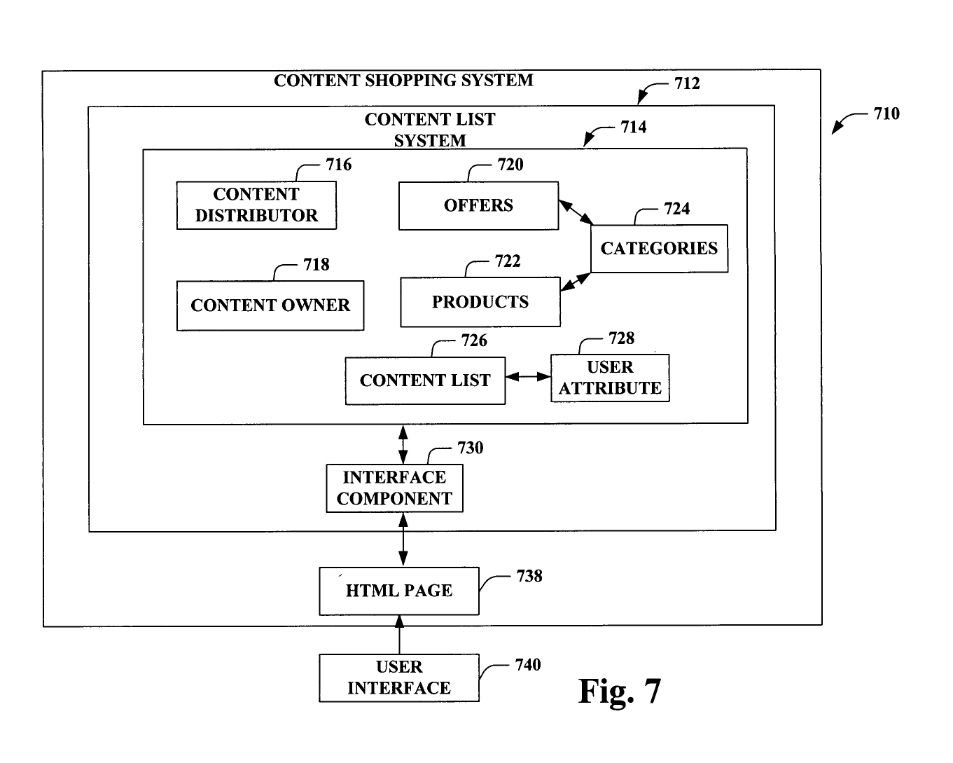

FIG. 7 illustrates components associated with a Content list system 712 being employed as part of a Content shopping system 710 associated with the Service for purchasing digital contents therefrom. The Content list system 712 includes a database system 714. The database system 714 includes a distributor database 716 for storing a number of different distributor names associated with the Content, an owner's database 718 for storing a number of Content owners' names, an offers database 720 for storing a number of offers for Contents and items offered by the owners and a products database 722 for a storing a plurality of Contents that are made available by the owners thru the DRM system of the present invention. A categories database 724 is provided for storing a variety of Content categories. The categories database 724 is illustrated as linked to the offers database 720 and the products database 722. Alternatively, the link from the offers database 720 can be a link to the products database 722, which is an indirect link to the categories database 724. If a category is requested by a user, a search through the offers database 720 and products database 722 will be executed based on particular query parameters being employed by a link to return offer and product results. A Content list database 726 is provided for saving data associated with one or more Content lists. A user attribute database 728 is linked to the Content list database by at least one Content list identification number or the like and stores data associated with attributes of the user. In one aspect of the invention, the user attribute database 728 can include user preferences for recommending additional items of interest of the user not in the user's Content list.

A user interface 740, such as an Internet browser, may receive a HTML page 738 when connecting with the Service. The HTML page 738 includes a number of images and/or links related to product offers, distributor information, Content and product description information and the like. The images and/or links are coupled to functional components residing on the Content list system 712. For example, the functional components can be a variety of ASPs, script components or executable components residing at the Content list system 712. Additionally, script code can reside in the HTML page itself and be passed to an interpreter and/or functional components residing on the Content list system 712.

A plurality of links from the HTML page 738 can be provided to an interface component 730 for providing a variety of functions to the Content shopping system 710 and the Content list system 712. For example, the interface component 730 can add offers to the Content list database 726. Furthermore, the interface component 730 provides the functionality necessary to display the contents of the Content list database 726. Upon receiving an instruction from the user to display the contents of the Content list database 726, the interface component 30 retrieves information from the Content list database 726 and uses this information as keys into the various databases. The interface component 730 then searches through at least one of the plurality of databases, distributors 716, owners 718, offers 720, products 722 and categories 724, and extracts the necessary data for displaying the contents of the Content list database 726.

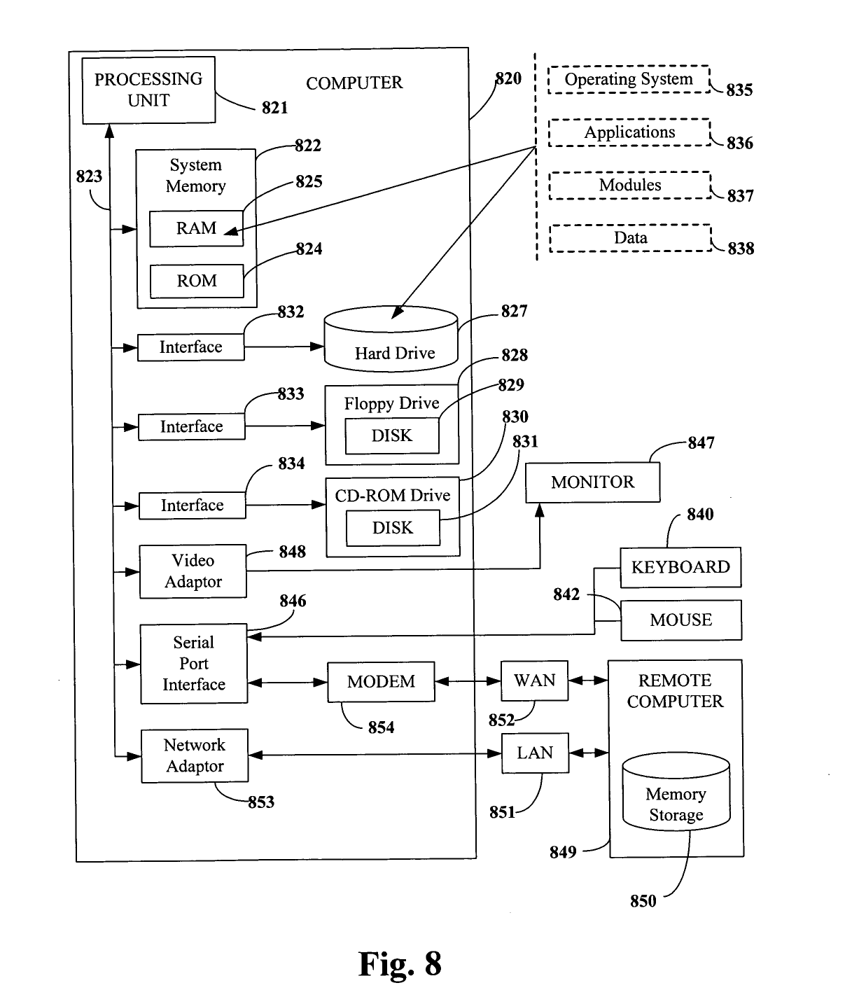

Referring now to FIG. 8, a brief, general description of a suitable computing environment on the client as well as the server side is illustrated wherein the various aspects of the present invention can be implemented. While the invention has been described above in the general context of computer-executable instructions of a computer program that runs on a computer and/or computers, those skilled in the art will recognize that the invention can also be implemented in combination with other program modules. Generally, program modules include routines, programs, components, data structures, etc. that perform particular tasks and/or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like. As explained earlier, the illustrated aspects of the invention can also be practiced in distributed computing environments where tasks are performed by remote processing devices that are linked through a communications network. However, some, if not all aspects of the invention can be practiced on stand-alone computers. In a distributed computing environment, program modules can be located in both local and remote memory storage devices. The exemplary includes a computer 820, including a processing unit 821, a system memory 822, and a system bus 823 that couples various system components including the system memory to the processing unit 821. The processing unit 821 may be any of various commercially available processors. Dual microprocessors and other multi-processor architectures also can be used as the processing unit 821.

The system bus may be any of several types of bus structure including a memory bus or memory controller, a peripheral bus, and a local bus using any of a variety of commercially available bus architectures. The system memory may include read only memory (ROM) 824 and random access memory (RAM) 825. A basic input/output system (BIOS), containing the basic routines that help to transfer information between elements within the computer 820, such as during start-up, is stored in ROM 824.

The computer 820 further includes a hard disk drive 827, a magnetic disk drive 828, e.g., to read from or write to a removable disk 829, and an optical disk drive 830, e.g., for reading from or writing to a CD-ROM disk 831 or to read from or write to other optical media. The hard disk drive 827, magnetic disk drive 828, and optical disk drive 830 are connected to the system bus 823 by a hard disk drive interface 832, a magnetic disk drive interface 833, and an optical drive interface 834, respectively. The drives and their associated computer-readable media provide nonvolatile storage of data, data structures, computer-executable instructions, etc. for the computer 820. Although the description of computer-readable media above refers to a hard disk, a removable magnetic disk and a CD, it should be appreciated by those skilled in the art that other types of media which are readable by a computer, such as magnetic cassettes, flash memory cards, digital video disks, Bernoulli cartridges, and the like, can also be used in the exemplary operating environment, and further that any such media may contain computer-executable instructions for performing the methods of the present invention.

A number of program modules can be stored in the drives and RAM 825, including an operating system 835, one or more application programs 836, other program modules 837, and program data 838. The operating system 835 in the illustrated computer can be substantially any commercially available operating system.

A user can enter commands and information into the computer 820 through a keyboard 840 and a pointing device, such as a mouse 842. Other input devices (not shown) can include a microphone, a joystick, a game pad, a satellite dish, a scanner, or the like. These and other input devices are often connected to the processing unit 821 through a serial port interface 846 that is coupled to the system bus, but may be connected by other interfaces, such as a parallel port, a game port or a universal serial bus (USB). A monitor 847 or other type of display device is also connected to the system bus 823 via an interface, such as a video adapter 848. In addition to the monitor, computers typically include other peripheral output devices (not shown), such as speakers and printers.

The computer 820 can operate in a networked environment using logical connections to one or more remote computers, such as a remote computer 849. The remote computer 849 may be a workstation, a server computer, a router, a peer device or other common network node, and typically includes many or all of the elements described relative to the computer 820, although only a memory storage device 850 is illustrated in FIG. 8. The logical connections depicted in FIG. 8 may include a local area network (LAN) 851 and a wide area network (WAN) 852. Such networking environments are commonplace in offices, enterprise-wide computer networks, Intranets and the Internet.

When employed in a LAN networking environment, the computer 820 can be connected to the local network 851 through a network interface or adapter 853. When utilized in a WAN networking environment, the computer 820 generally can include a modem 854, and/or is connected to a communications server on the LAN, and/or has other means for establishing communications over the wide area network 852, such as the Internet. The modem 854, which can be internal or external, can be connected to the system bus 823 via the serial port interface 846. In a networked environment, program modules depicted relative to the computer 820, or portions thereof, can be stored in the remote memory storage device. It will be appreciated that the network connections shown are exemplary and other means of establishing a communications link between the computers can be employed.

In accordance with the practices of persons skilled in the art of computer programming, the present invention has been described with reference to acts and symbolic representations of operations that are performed by a computer, such as the computer 820, unless otherwise indicated. Such acts and operations are sometimes referred to as being computer-executed. It will be appreciated that the acts and symbolically represented operations include the manipulation by the processing unit 821 of electrical signals representing data bits which causes a resulting transformation or reduction of the electrical signal representation, and the maintenance of data bits at memory locations in the memory system (including the system memory 822, hard drive 827, floppy disks 829, and CD-ROM 831) to thereby reconfigure or otherwise alter the computer system's operation, as well as other processing of signals. The memory locations wherein such data bits are maintained are physical locations that have particular electrical, magnetic, or optical properties corresponding to the data bits.

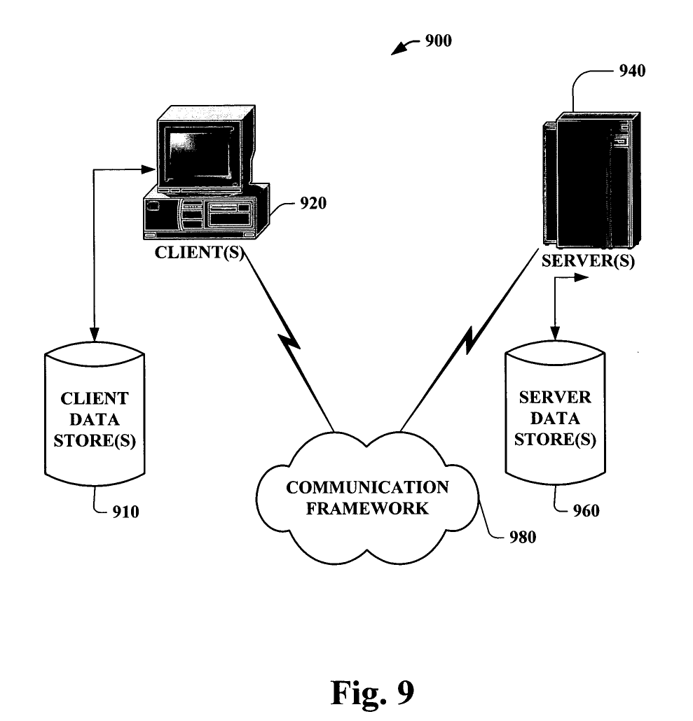

Referring now to FIG. 9, a client-server system 900 that employs a data manipulation methodology according to one aspect of the present invention is illustrated. The client(s) 920 can be hardware and/or software (e.g., threads, processes, computing devices). The system 900 also includes one or more server(s) 940. The server(s) 940 can also be hardware and/or software (e.g., threads, processes, computing devices). For example, such servers 940 can house threads to perform transformations by employing the present invention. The client 920 and the server 940 can communicate, in the form of data packets transmitted according to the present invention, between two or more computer processes. The client/server can also share the same process. As illustrated, the system 900 includes a communication framework 980 that can facilitate communications between the client(s) 920 and the server(s) 940. The client(s) 920 is operationally connected to one or more client data store(s) 910 that can store information local to the client(s) 920. Moreover, client 920 can access and update databases 960 located on a server computer 940 running a server process. In one aspect of the present invention, the communication frame work 980 can be the internet, with the client process being a Web browser and the server process being a Web server. As such, a typical client 920 can be a general purpose computer, such as a conventional personal computer having a central processing unit (CPU), system memory a modem or network card for connecting the personal computer to the Internet, and a display as well as other components such as a keyboard, mouse, and the like. Likewise a typical server 940 can be university or corporate mainframe computers, or dedicated workstations, and the like.

Although the invention has been shown and described with respect to certain illustrated aspects, it will be appreciated that equivalent alterations and modifications will occur to others skilled in the art upon the reading and understanding of this specification and the annexed drawings. In particular regard to the various functions performed by the above described components (assemblies, devices, circuits, systems, etc.), the terms (including a reference to a “means”) used to describe such components are intended to correspond, unless otherwise indicated, to any component which performs the specified function of the described component (e.g., that is functionally equivalent), even though not structurally equivalent to the disclosed structure, which performs the function in the herein illustrated exemplary aspects of the invention. In this regard, it will also be recognized that the invention includes a system as well as a computer-readable medium having computer-executable instructions for performing the acts and/or events of the various methods of the invention. Furthermore, to the extent that the terms “includes”, “including”, “has”, “having”, and variants thereof are used in either the detailed description or the claims, these terms are intended to be inclusive in a manner similar to the term “comprising.”

What is claimed is:

1. A system that facilitates digital rights management (DRM), comprising:
a registration component that registers a user and associates a plurality of devices with the user; and
a DRM component that issues a license for a Content purchased by the user, for use of the Content on the plurality of devices.

2. The system of claim 1, another user shares a subset of the plurality of devices with the user, to use purchased content on the subset.

3. The system of claim 1, the license is associated with a DRM challenge.

4. The system of claim 1, further comprising a Task Queue that stores Contents or licenses associated with the user.

5. The system of claim 1, further comprising a tracking component that tracks Contents purchased by the user and a device to which license(s) have been downloaded.

6. The system of claim 1, the Service further comprising an Internet Key Exchange.

7. The system of claim 3, the license is encrypted to a public key encrypted in the DRM challenge.

8. The system of claim 3, the license is unique to the device and the content.

9. The system of claim 3, the device being unregistered for a specific user.

10. The system of claim 3, the DRM challenge incorporates a versioning scheme.

11. The system of claim 3, further comprising a security component that restricts access the content on a subset of the devices.

12. The system of claim 3, further comprising a central device that receives a main license and issues sublicenses to other devise.

13. The system of claim 12, the central device functions as broadcasting center for the other devices.

14. A method of facilitating digital rights management (DRM) comprising:
registering a user and a plurality of devices thereof with a Service; and
issuing licenses for contents purchased by the user, each license ties one content to one device, and enables use of the contents on the plurality of devices.

15. The method of claim 14 further comprising sharing a device from the plurality of devices with another user purchasing content from the Service.

16. The method of claim 14 further comprising receiving a DRM challenge by the Service from a device.

17. The method of claim 16 further comprising issuing a license to the device based on the DRM challenge of the device.

18. The method of claim 16 further comprising encrypting a license into a key of the DRM challenge.

19. The method of claim 14 further comprising disabling a license by the Service.

20. The method of claim 15 further comprising registering a same device by multiple users with the Service.

21. The method of claim 14 further comprising unregistering a device with the Service.

22. The method of claim 21 further comprising performing a reference count on the device to be unregistered to determine whether the device is shared by other users.

23. The method of claim 22 further comprising maintaining a license for contents purchased by other users.

24. The method of claim 14 further comprising issuing licenses to a main device that further issues sublicenses to other devices.

25. The method of claim 24 further comprising broadcasting Content via the main device to the other devices.

26. A computer readable medium having stored thereon computer executable instructions for carrying out the method of claim 14.

27. A computer-readable medium having stored thereon a data structure comprising:
a computer executable component that registers a user and associates a plurality of devices with the user; and
a further computer executable component that issues licenses for contents purchased by the user in response to a DRM challenge sent by a device, for use of the contents on the plurality of devices.

28. The computer readable medium of claim 27 further comprising a component that tracks licenses issued to the plurality of devices.

29. A method of facilitating digital rights management (DRM) comprising:
registering a user and a plurality of devices thereof with a Service; and
issuing a license for a content for use on the plurality of devices, each license ties one content to one device.

30. A system that facilitates digital rights management (DRM), comprising:
means for registering a user and associating a plurality of devices with the user; and
means for issuing licenses for contents purchased by the user, for use on the plurality of devices.

31. The system of claim 30 further comprising means for tracking contents purchased by the user and the plurality of devices the licenses have been downloaded thereto.
